(19) United States
(12) Patent Application Publication
(10) Pub. No.: US 2014/0132084 A1
(43) Pub. Date: May 15, 2014

(54) CONTROLLABLE ELECTRICAL RECEPTACLE WITH ROUTED ANTENNA

(71) Applicant: LEVITON MANUFACTURING COMPANY, INC., Melville, NY (US)

(72) Inventors: Hoa Pham, Tualatin, OR (US); Dan Wright, Beaverton, OR (US); Jason Betournay, Portland, OR (US); Subramanian Muthu, Portland, OR (US)

(73) Assignee: LEVITON MANUFACTURING COMPANY, INC., Melville, NY (US)

(21) Appl. No.: 13/674,144

(22) Filed: Nov. 12, 2012

(51) Int. Cl. H02J 13/00

(52) U.S. Cl. CPC H02J 13/0075
USPC 307/140

(57) ABSTRACT

A controllable electrical receptacle is disclosed. The electrical receptacle includes a housing having a pair of sockets suitable for receiving electrical plugs. The receptacle includes an antenna disposed beneath a cover portion of the receptacle. The antenna is configured to receive wireless signals from an occupancy sensor or other controller and to control power to the sockets based on the received signals. The antenna is also configured to transmit wireless signals. The antenna may be routed around the sockets to minimize interference caused by metal components of the receptacle. The antenna may be sandwiched between a pair of non-metal layers of the housing to avoid direct exposure to the environment while maintaining a desired performance. In one embodiment the antenna is a wire member received within a routing groove formed in a portion of the housing. The routing groove includes features for retaining the wire member in the groove.

### FIELD OF THE DISCLOSURE

The disclosure generally relates to an electrical receptacle having an antenna, and more particularly to a wirelessly controlled electrical receptacle configured to receive and transmit wireless signals for controlling the electrical outlets of the electrical receptacle and for providing information relating to the operation of the receptacle.

### BACKGROUND OF THE DISCLOSURE

Electrical receptacles provide a convenient means of supplying electrical power to electrical devices or appliances. In particular, indoor and outdoor lighting, appliances, and the like make use of an electrical distribution system through access of these electrical receptacles located in the interior and/or exterior walls of building structures such as homes and commercial buildings.

Energy efficiency has become an increasingly important aspect of building design. To that end, many buildings now include programmable heating and cooling controls, and occupancy sensors are often used to control lighting so that rooms are lit only when occupied. In typical applications, a constant source of electrical power is supplied to electrical receptacles. As such, responsibility for energy efficient operation is pushed out to the component level (i.e., the component must either be timed to turn off after a pre-determined period or must be manually switched on/off). Since appliances such as televisions, cable converter boxes, copiers and the like can consume a substantial amount of electrical power even when not in use (i.e., when in standby mode), these arrangements do not provide for effective comprehensive control of the use of electrical power throughout a home or building.

It would be desirable to provide an electrical receptacle that is controllable so that one or more of the electrical outlets can be turned on/off according to an external control. It would also be desirable to provide for independent control of the individual sockets of the receptacle so that power to a pair of appliances connected to the socket could be independently turned on/off. The electrical receptacle should be remotely controllable via a wireless communications protocol so as to eliminate the need for hard control wiring.

### SUMMARY OF THE DISCLOSURE

A controllable electrical receptacle is disclosed, comprising a housing having a first housing portion with openings comprising at least one electrical socket. The receptacle may also include an antenna at least partially disposed within a groove in a front face of said first housing portion. The groove may be routed around the at least one electrical socket. The antenna may comprise a wire element having a rearward extending portion and a forward facing portion, where the rearward extending portion is coupled to a circuit, and the forward facing portion is positioned within the groove. The receptacle may also include a wireless transceiver coupled to the circuit. The wireless transceiver may be configured to receive wireless signals and to control power to the at least one socket in response to the wireless signals.

An electrical receptacle is disclosed, comprising a housing having a first housing portion, where the first housing portion includes an electrical socket. The electrical receptacle may also include an antenna having a rearward extending portion and a forward facing portion. The rearward extending portion may be coupled to a circuit, while the forward facing portion may be positioned within a groove in the first housing portion. The groove may be routed around the electrical socket. The electrical receptacle may further include a wireless transceiver coupled to the circuit. The wireless transceiver may be configured to receive wireless signals and to control power applied to the socket in response to the wireless signals.

A controllable electrical receptacle system is disclosed. The system may include a controllable electrical receptacle comprising a first housing portion with openings comprising at least one electrical socket, and an antenna received within a groove in a front face of said first housing portion. The groove may be routed around the at least one electrical socket. The antenna may comprise a wire element having a rearward extending portion and a forward facing portion, where the rearward extending portion is coupled to a circuit, and the forward facing portion is disposed within the groove. The system may further include a wireless transceiver coupled to the circuit. The wireless transceiver may be configured to receive wireless signals and to control power to the at least one socket in response thereto. The system may additionally include a wireless device configured to transmit the wireless signals in response to a sensed occupancy condition in a monitored space.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the present invention may be more readily understood by one skilled in the art with reference being had to the following detailed description of several embodiments thereof, taken in conjunction with the accompanying drawings wherein like elements are designated by identical reference numerals throughout the several views, and in which:

FIG. 1 is an exemplary embodiment of a wireless occupancy sensing system having a controllable electrical receptacle according to the disclosure;

FIG. 2 is a schematic of a portion of the wireless occupancy sensing system of FIG. 1;

FIG. 3 is a schematic of an exemplary controllable electrical receptacle according to the disclosure;

FIG. 4 is an isometric view of an exemplary electrical receptacle according to the disclosure;

FIG. 5 is a cross-section view of the electrical receptacle of FIG. 4 taken along line 5-5 of FIG. 4;

FIG. 6 is an exploded isometric view of the electrical receptacle of FIG. 4;

FIG. 7 is an isometric view of an exemplary middle housing portion of the electrical receptacle of FIG. 4;

FIG. 8 is an isometric view of an exemplary antenna of the electrical receptacle of FIG. 4;

FIGS. 9A and 9B are isometric and top plan views, respectively, of an exemplary first housing portion of the electrical receptacle of FIG. 4;

FIGS. 10A and 10B are exemplary isometric and reverse isometric views, respectively, of an antenna cover of the electrical receptacle of FIG. 4;

FIGS. 11A and 11B are exemplary isometric and reverse isometric views, respectively, of a cover plate of the electrical receptacle of FIG. 4;

FIG. 12 is an exemplary matching circuit for use with the antenna of FIG. 8;

FIG. 13 is a partial transparent isometric view of an alternative embodiment of an antenna for use with the electrical receptacle of FIG. 4, wherein the antenna is fit within an alternative embodiment of a top housing portion;

FIG. 14 is an exemplary embodiment of a wireless occupancy sensing system having a controllable electrical receptacle connected in series with a plurality of conventional receptacles; and

FIG. 15 is an exemplary system for monitoring load usage via the controllable receptacle 6 of FIG. 4.

### DETAILED DESCRIPTION

An electrical receptacle is disclosed for use in conjunction with one or more wireless occupancy sensors, unpowered switches, keycards, and other wireless devices now or hereafter known to selectively control one or more connected alternating current (AC) powered loads. The receptacle may be wireless, and may be configured to facilitate local or remote access for programming, monitoring, and controlling connected loads for a building in order to optimize the efficiency of controlled devices based on schedules, occupancy, demand response, and/or local input. Embodiments will be described below while referencing the accompanying figures. The accompanying figures are merely examples and are not intended to limit the scope of the present disclosure.

In one embodiment, the receptacle includes a wireless transceiver coupled to an antenna that is sandwiched between non-metallic layers of the receptacle. The antenna may be tuned for optimal performance and may be routed within the receptacle in a manner that keeps it as far away from any metal portions as possible, thus minimizing unwanted electrical interference.

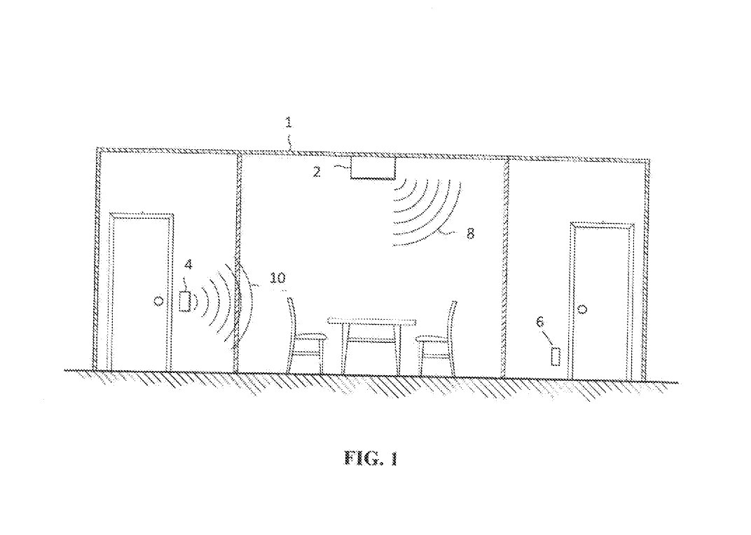

An exemplary embodiment of an occupancy sensing and receptacle control system is shown in FIG. 1. In the illustrated embodiment, a room 1 may be adapted to include one or more wireless occupancy sensors 2, one or more wireless wall switches 4, and at least one controllable receptacle 6. The receptacle 6 can include a wireless transceiver, a power switch to control power delivered to a connected load, and a controller as will be described in greater detail later. In practice, the room 1 can include multiple accessible receptacles 6, each of which may be responsive to the same occupancy sensor 2 and/or wall switch 4. For example, one receptacle 6 may be mounted near the floor, as shown in FIG. 1, while another receptacle (not shown) can be mounted on the wall or other appropriate location. As will be appreciated, multiple loads can be controlled using multiple receptacles 6. For example, a wall mounted receptacle could be configured to turn off overhead lighting as soon as an occupant has left the room, while a floor mounted receptacle could be configured to turn off another load, such as a computer, printer, monitor, or the like after a longer time delay.

In an embodiment, the wireless occupancy sensor 2 can be configured to transmit a signal 8 indicating that an occupant has been detected in the space. Such a signal may be received by the receptacle 6, and the receptacle 6 can be configured to supply power to a connected load. In some embodiments, the wireless occupancy sensor 2 may be configured so that if an occupant is not detected, the sensor does not transmit a signal. In such cases, the receptacle 6 may be configured to turn off power to the connected load immediately or after a predetermined delay period, as will be described in greater detail later.

The wireless switch 4 can be configured to transmit a signal to the receptacle 6 in a manner similar to the occupancy sensor 2. For example, the wireless switch 4 can transmit a switch signal 10, and the receptacle 6 can be configured to receive the switch signal 10 and supply power (or shut off power) to a connected load as appropriate.

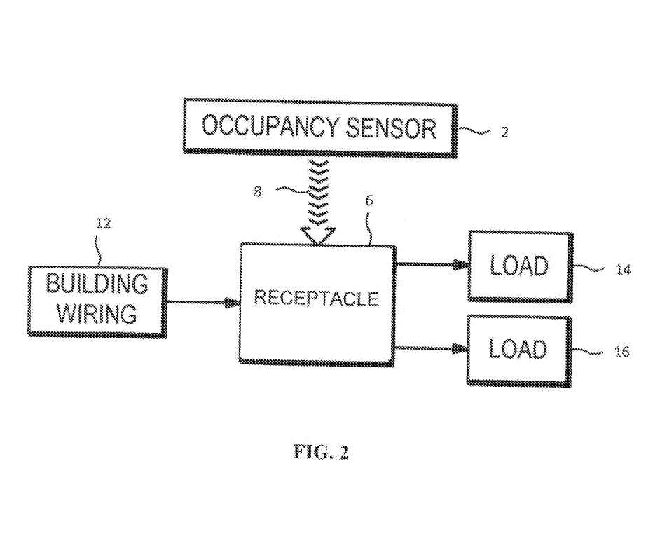

FIG. 2 illustrates an embodiment of a wireless occupancy sensing system having a receptacle 6 as shown in FIG. 1. The system of FIG. 2 includes a controllable receptacle 6 for controlling the flow of power from a building wiring system 12 to first and second electrical loads 14, 16 in response to a wireless signal 8 received from the occupancy sensor 2. The receptacle 6 may control the loads 14, 16 together or independently in response to the wireless signal from the occupancy sensor 2. For example, in some embodiments, one of the loads 14 may always be energized, or may be controlled by a master switch, while the other load 16 may be controlled by the wireless signal 8 from the occupancy sensor 2. In other embodiments, both loads 14, 16 may be controlled by the wireless signal from the occupancy sensor, but with different delay times, different levels of sensitivity, etc. In yet other embodiments, one of the loads 14 may be controlled by the wireless signal from the occupancy sensor 2, while the other load may be controlled by a combination of an ambient light detector, as well as the wireless signal from the occupancy sensor.

In some embodiments, the wireless signal from the occupancy sensor 2 may be implemented as an occupancy signal that provides a relatively high-level indication of whether the monitored space is occupied or not. For example, the wireless signal may be encoded as a binary signal where one state indicates the space is occupied, and the other state indicates the space is not occupied. A binary occupancy signal may have refinements such as a delay time integrated into the signal, i.e., the signal does not switch from the occupied to the unoccupied state until the space has been unoccupied for the entire duration of the delay time. In other embodiments, the wireless signal from the occupancy sensor may be implemented as a detector signal that provides a relatively low-level indication of a physical stimulus being sensed by a detector in the occupancy sensor. For example, in an occupancy sensor that uses passive infrared (PIR) sensing technology, the wireless signal may be encoded to transmit primitive signals or raw data from the PIR detector. Such signals or data may then be processed in the controllable receptacle to determine whether the monitored space is occupied.

While the FIG. 2 embodiment describes control of the receptacle 6 via a signal 8 received from the occupancy sensor 2, it will be appreciated that the same or similar control of the receptacle 6 can be achieved via one or more wall switches 4. In addition, the receptacle 6 may be configured to receive wireless signals 8 from a plurality of occupancy sensors 2 mounted at different locations in a monitored space. It is to be understood that in the exemplary embodiment of FIG. 2, there is one occupancy sensor and two loads, but other embodiments may include any number of occupancy sensors, loads, and/or switches connected to the receptacle 6, including but not limited to, one, two, three, four, etc. Furthermore, there may be any number of receptacles 6, including but not limited to, one, two, three, four, etc.

The wireless occupancy sensor 2 may use any of a variety of technologies in order to determine whether the associated space is occupied, including passive infrared energy (PIR), a video image, an audio signal can be captured, or combinations thereof. In addition, in this and any other embodiments, the wireless signal from the occupancy sensor may be transmitted to the receptacle 6 using any suitable wireless transmission technology. Examples include infrared transmission using a standard from the Infrared Data Association (IrDA), RF transmission using one of the many standards developed by the Institute of Electrical and Electronic Engineers (IEEE), or any other standardized and/or proprietary wireless communication technology.

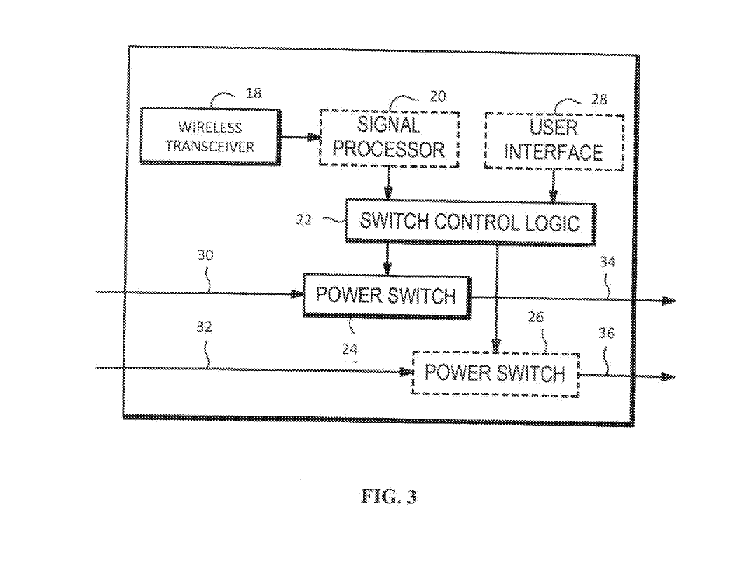

FIG. 3 illustrates an embodiment of the controllable receptacle 6 according to the disclosure. The receptacle 6 of FIG. 3 includes a wireless transceiver 18 configured to receive a wireless signal from an occupancy sensor using any suitable wireless transmission technologies, including those discussed above. The transceiver 18 may also be configured to transmit a wireless signal as will be described in greater detail later. A signal processor 20 may be included depending on the nature of the wireless signal. If the wireless signal 8 is implemented as an occupancy signal that provides a relatively high-level indication of whether the monitored space is occupied, the signal processor may be omitted. In other embodiments, if the wireless signal 8 from the occupancy sensor 2 is implemented as a detector signal the signal processor may be included to process the detector signal and determine whether the monitored space is occupied.

Switch control logic 22 may control a power switch 24 in response to an occupancy signal from the transceiver and/or the signal processor. The switch control logic 22 may also control one or more additional power switches 26. A power switch may include any suitable form of isolated or non-isolated power switch, including but not limited to, an air-gap relay, solid state relay, or other switch based on SCRs, triacs, transistors, etc. The switch may provide power switching in discrete steps such as on/off switching, with or without intermediate steps, or continuous switching such as dimming control.

A user interface 28 may be included to enable a user to configure the system, adjust parameters, etc. For example, the user interface 28 may enable a user to set an unoccupied delay time, detector sensitivity, learn mode, manual mode, automatic mode, and the like. The user interface 28 may be implemented with any level of sophistication from a simple push-button switch, to a keypad with full text display, etc. For example, in some embodiments, a user interface may include a trimming potentiometer (trim pot) or a dip switch to set a delay time for unoccupied mode. It will be appreciated that the receptacle 6 may also be wirelessly programmable in the same manner so that a user can program the receptacle via an appropriate wireless device. For example, the user interface may be an external wireless device, such as, but not limited to, a computer, touchscreen, tablet, smart phone, etc.

The power connections to the power switches 24, 26 may be implemented in any suitable manner. For example, in some embodiments, the input power connection 30 may include a standard grounded or ungrounded power cord with a plug for connection to a wall receptacle. In other embodiments, the input power connection may include a screw base to connect the switching device to a standard screw-type light socket. In embodiments that include more than one power switch, additional power inputs 32 may be connected to the same or separate input power connections.

Since the controllable receptacle 6 of FIG. 3 includes at least one power connection 30, 32, one of these connections may be utilized as a source of power to operate the wireless transceiver 18, signal processor 20, user interface 28, logic 22, etc. Alternatively, a separate power source such as one or more batteries, PV cells, etc. may be used as a primary or back-up source of power to operate this circuitry.

The connection from a power switch 24 to a connected load (not shown) may also be implemented in any suitable manner. For example, in some embodiments, the connection 34 from the switch 24 may include one or more sockets for a standard power plug, or a ground fault circuit interrupter (GFCI). In an embodiment having two sockets, one of the switches 24 may be configured to switch power to one socket in response to the wireless signal 8 from the occupancy sensor 2 under control of the switch control logic 22, while the other socket may be configured to switch a separate group of connected loads on at all times, or only turn off in response to a master on-off switch on the power strip.

In another embodiment having two sockets in a receptacle 6, the two sockets may both be configured to be controlled by the wireless signal 8 from an occupancy sensor 2, but the switch control logic 22 may cause the two switches 24, 26 to control separate groups of sockets (via respective connections 34, 36) using the same or different delay times.

In other embodiments, the switch control logic 22 may be configured to provide various types of overrides such as manual or timer overrides of the occupancy sensor 2 for certain loads. For example, a specific receptacle for a coffee maker may be configured to remain energized for a fixed length of time, regardless of occupancy, to assure a completely brewed pot of coffee. The user 28 interface may be configured to enable a user to select a specific socket of the receptacle 6 and designate the override time and other parameters.

As another example, one socket coupled to a networked printer that is normally controlled by the occupancy sensor may be manually and temporarily overridden to remain on, for example, if the occupant knows that others will be sending network print jobs to the printer while the occupant is away from the monitored space. As yet another example, one group of receptacles and/or sockets for devices such as a monitor, printer, background music, etc., may be configured to turn off after the monitored space is unoccupied for 10 minutes, while a second group of receptacles and/or sockets for devices such as a computer CPU may be configured to turn off after the monitored space is unoccupied for one hour.

It will be appreciated that the switch control logic 22 and circuitry may be implemented with analog and/or digital hardware, software, firmware, etc., or any combination thereof.

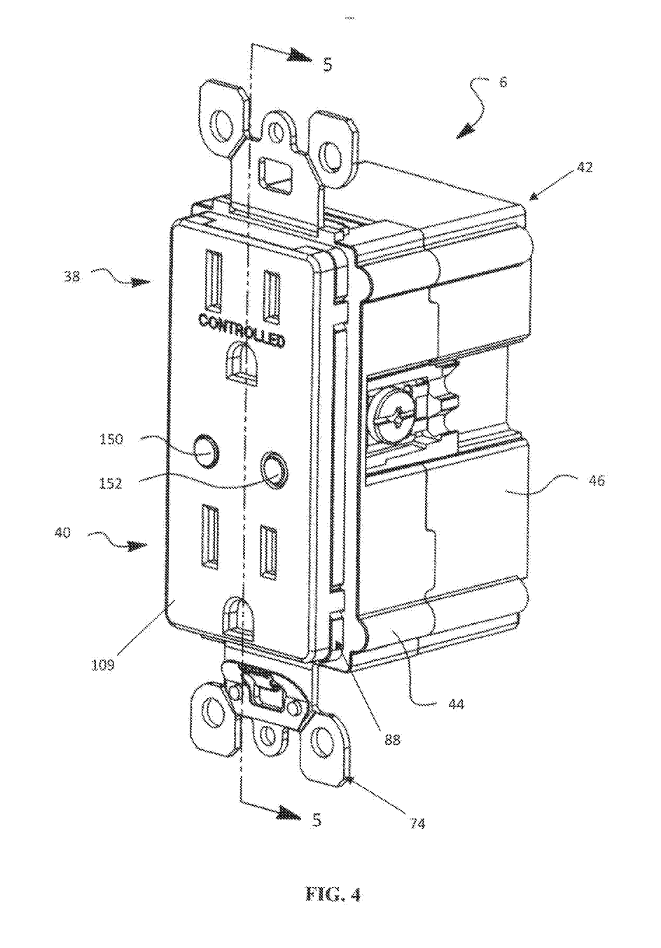

Referring to FIGS. 4 and 5, controllable electrical receptacle 6 and components thereof are shown according to an exemplary embodiment. As previously noted, the receptacle 6 may be installed within or mounted to a wall, a ceiling, a floor and/or any other area or surface where it would be desirable to provide a connection point to a power source. According to the various alternative embodiments, receptacle 6 can include one or more electrical sockets 38, 40 each configured as a two-prong electrical receptacle and/or may be configured as a receptacle other than that of a duplex receptacle (e.g., a single receptacle, a triplex receptacle, etc.). Alternatively, electrical receptacle 6 may include one or more outlets of any suitable configuration.

One or more of first electrical socket 38 and second electrical socket 40 may be configured to be selectively actuated (e.g., powered on/off, etc.) via a wireless signal in the manner previously described. In one embodiment, first electrical socket 38 is configured to be actuated via a wireless a control device, while second electrical socket 40 is configured to be wired to a main power source such as 110 volts AC. In another embodiment, both first electrical socket 38 and second electrical socket 40 are configured to be selectively actuated via a wireless control device either independently or together.

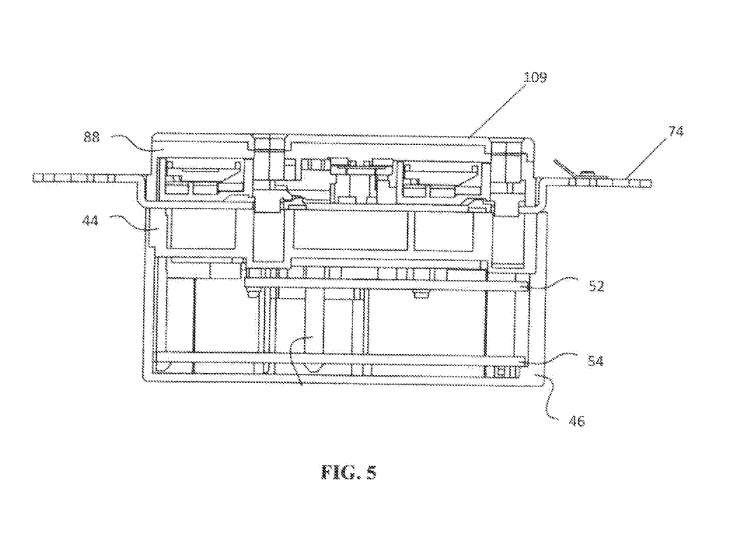

The receptacle 6 includes a housing 42 having a first portion 44 (illustrated as a top cover portion), and a second portion 46 (illustrated as a back cover portion). The first portion 44 may be removably coupled to the second portion 46 using one or more suitable fasteners, shown as screws 48 in FIG. 6, which are inserted through holes that extend through the second portion 46 and partially into the first portion 44. The first and second portions 44, 46 substantially enclose and protect the components of the receptacle 6, including a middle potion 50 (often referred to as a rack) shown in FIGS. 5-7.

Middle portion 50 provides a base or platform for supporting at least some of the components of receptacle 6. In one embodiment, middle portion 50 is a one-piece molded structure formed of a dielectric material, such as plastic. In other embodiments, the middle portion may be of any suitable insulating material and/or provided in any number of pieces. Components can be supported on both a front and back side of middle portion 50. To support such components, middle portion 50 includes a number of projections that define a number of cavities, passageways and/or platforms configured to receive and support the components.

Supported at the back side of middle portion 50 are first and second printed circuit boards 52, 54. According to an exemplary embodiment, first printed circuit board 52 may include switch control logic 22, while second printed circuit board 54 may include a power circuit 56. The first and second printed circuit boards 52, 54 are supported by the middle portion 50 of the housing 42 in a spaced apart relation, separated by a dielectric layer 53, with the first printed circuit board 52 being positioned closer to the middle portion 50 than the second printed circuit board 54 is positioned. The first printed circuit board 52 may include a ground plane 58 configured to connect to an antenna 60. As will be described in greater detail later, the first circuit board 52 may also be configured to create a matching impedance to the antenna 60.

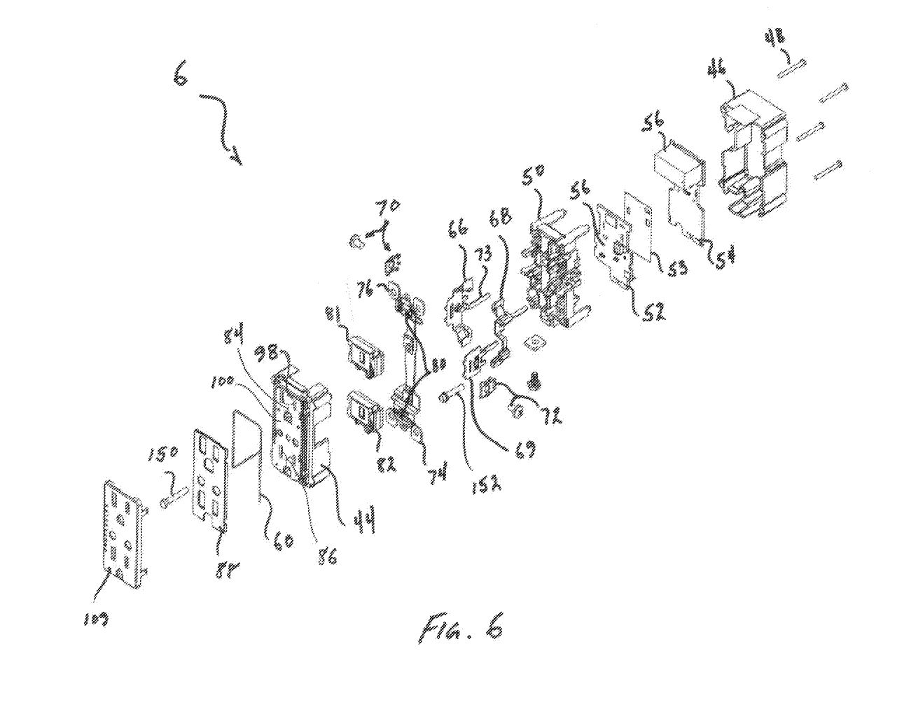

The middle portion 50 may support the first circuit board 52 via a plurality of first projections 62 (see FIG. 7), and may support the second circuit board 54 via a plurality of second projections 64 disposed at the peripheral corners of the middle portion 50. The plurality of first and second portions 62, 64 may include barbs at their free ends for engaging the respective circuit boards. The projections 62, 64 may also include shoulder portions configured to engage the first and second circuit boards to further assist in maintaining the boards in the desired spaced apart relation.

Referring now to FIG. 6, further components of the controllable receptacle 6 will be described. As can be seen, and as previously described, first and second housing portions 44, 46 enclose first and second printed circuit boards 52, 54 which are supported on middle portion 50. Supported on the front side of middle portion 50 is a neutral current pathway structure 66, a HOT current pathway structure 69, and a load/relay structure 68. When the relay closes the remaining load pathway on structure 68 is complete delivering HOT to the load circuit of both receptacles inputs of FIG. 6. Neutral and HOT current pathway structures 66, 69 are configured to be coupled to the power source by having respective electrical wires engage respective screw and clamp assemblies 70, 72. According to an exemplary embodiment, a neutral output lead 73 extends through an opening defined in first circuit board 52 and is coupled to second circuit board 54. The neutral current pathway structure 66 may be supported on one side of the housing middle portion 50.

According to the embodiment illustrated, HOT current pathway structure 69 includes two separate structures, each of which is associated with a respective wirelessly controlled first or second socket 38, 40. HOT current pathway structure 69 is configured to be coupled to the power source via the second circuit board 54, which allows the power to the first and second electrical sockets 38, 40 to be selectively controlled. The first circuit board 52 controls a relay on the second circuit board. As the relay closes, HOT flows to the controlled electrical sockets. The HOT current pathway structure 69 may be supported by the housing middle portion 50.

As an alternative, the receptacle 6 could include the HOT, neutral and load pathways that are configured, and may function, the same as those described in U.S. Pat. No. 8,105,094 to Patel et al., the entirety of which is incorporated by reference herein.

A mounting strap 74 may be disposed between the housing first portion 44 and the housing middle portion 50 to facilitate the mounting of the receptacle 6 to an electrical box (e.g., wall box, etc.) using screws positioned through openings in the first and second tab portion 76, 78. The mounting strap 74 may also have one or more self-grounding clips 80 configured to establish a grounding connection between the receptacle 6 and an electrical box.

As can be seen, the mounting strap 74 may be positioned between the first portion 44 and the middle portion 50. Positioned between the mounting strap 74 and the first portion 44 may be tamper resistant devices 81, 82 associated with the first and second electrical sockets 38, 40, respectively. The tamper resistant devices 81, 82 are configured to block entry ports 84, 86 in the first portion 44 of the housing unless a mating electrical plug is inserted into the socket. The tamper resistant devices 81, 82 may be configured, and may function, the same as the tamper resistant described in U.S. Pat. No. 8,105,094 to Patel et al., the entirety of which is incorporated by reference herein.

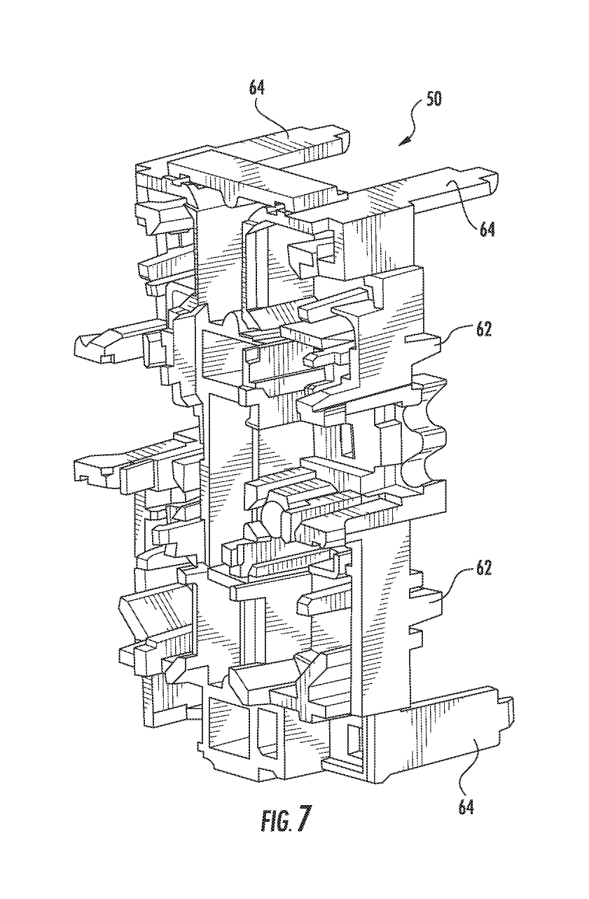

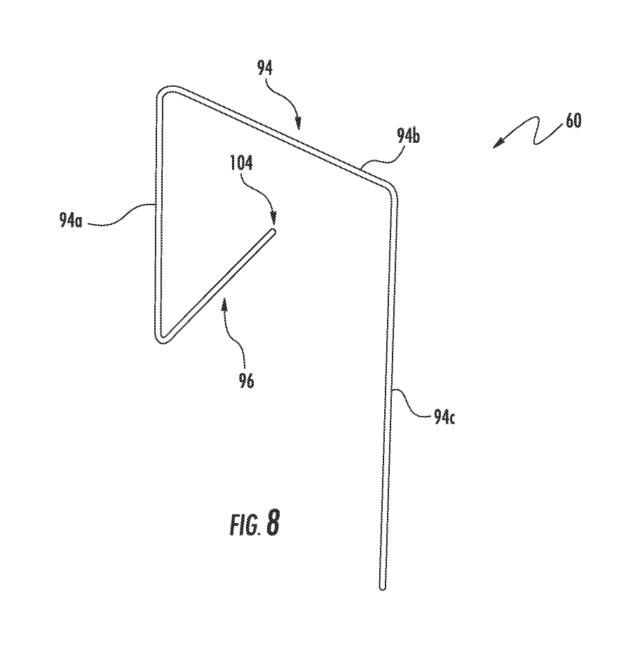

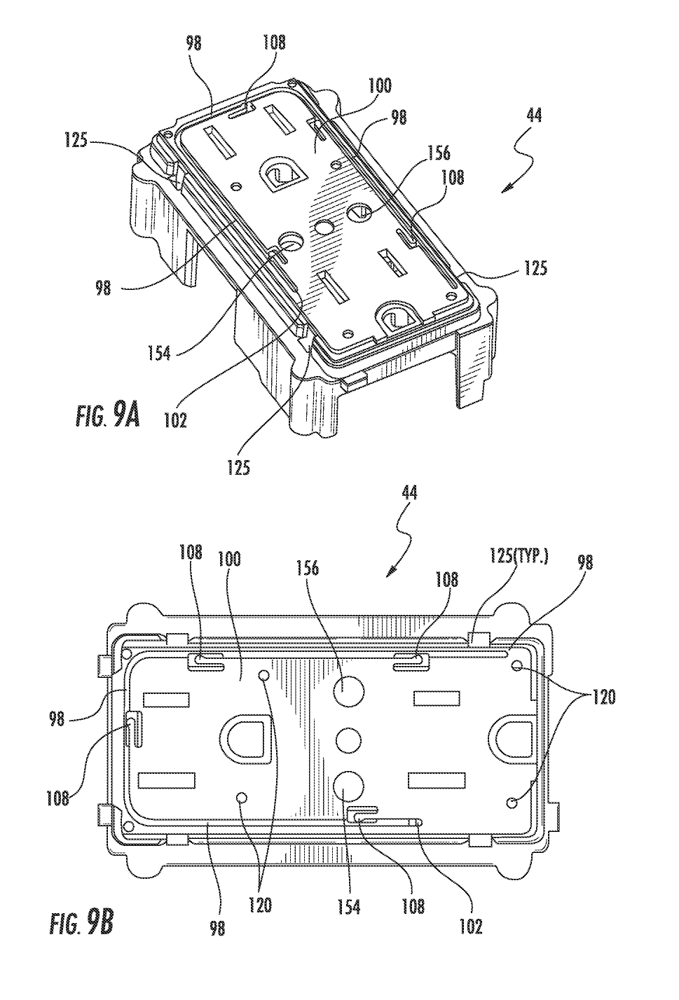

The antenna 60 may be tuned for optimal performance and may be routed within the receptacle in a manner that keeps it as far away from any metal portions as practical, thus minimizing unwanted electrical interference. The antenna 60 may be sandwiched between the first portion 44 of the housing 42 and an antenna cover 88. In the illustrated embodiment, the antenna 60 (shown in detail in FIG. 8) comprises a wire member having a forward facing portion 94 (94a-c) and a rearward extending portion 96. The forward facing portion 94 can be received within a correspondingly-shaped groove 98 (see FIGS. 9A, 9B) formed in a forward face 100 of the first portion 44 of the housing. The rearward extending portion 96 passes through an opening 102 in the first portion 44 and also through an opening (not shown) in the middle portion 50, and is coupled at a distal end 104 to the first printed circuit board 52.

The described positioning of the antenna 60, in which the forward facing portion 94 of the antenna 60 is routed around the first and second sockets 38, 40, and is sandwiched between the non-metallic first portion 44 and the non-metallic antenna cover 88, minimizes interference that can be caused by the metal portions of the receptacle 6 and metal aspects of one or more plugs that may be inserted into the sockets. In addition, the described positioning also minimizes interference from the presence of a decorative metal cover plate that can be installed around the receptacle 6 to provide the receptacle with a finished look. In addition, because the antenna 60 is sandwiched between the non-metallic elements, the possibility that the antenna could come into contact with a user or could be damaged through external contact is eliminated.

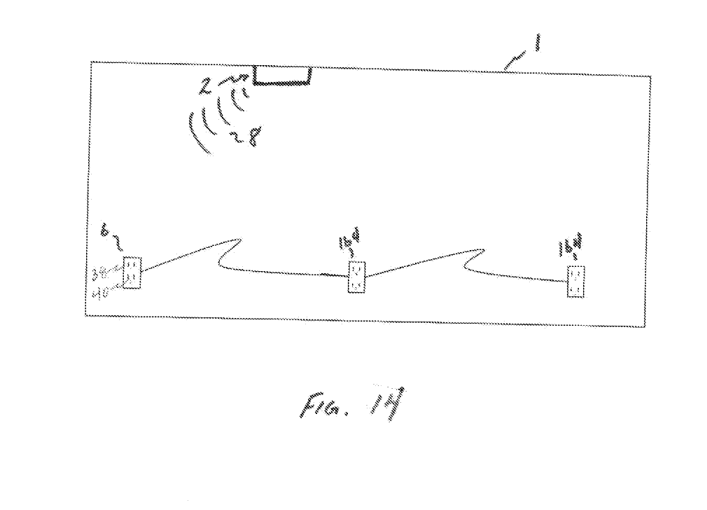

As noted, the forward facing portion 94 of the antenna 60 may be received within a groove 98 formed in the forward face 100 of the first portion 44 of the housing. The groove 98 may be sized and shaped to receive the antenna 60, which may be preformed, or it may be formed by pressing the wire body of the antenna into the groove. In the illustrated embodiment, the forward facing portion 94 of the antenna is substantially U-shaped. It will be appreciated, however, that this is merely exemplary and that other shapes and routings of the antenna may also be used (see, e.g., FIG. 13)

The groove 98 is dimensioned so that it can receive at least a portion of the antenna 60. In the illustrated embodiment, the groove 98 is sized to receive the entire diameter of the antenna such that, once installed, the antenna 60 does not extend about the forward face 100 of the first portion 44. The antenna cover 88 then lays flat over the top of the groove 98 and the forward facing portion 94 of the antenna. In other embodiments, the groove 98 may only partially receive the forward facing portion 94 of the antenna and the antenna cover 88 may receive the opposing portion of the antenna.

To hold the forward facing portion 94 of the antenna 60 within the groove 98, a plurality of resilient fingers 108 (FIGS. 9A, 9B) are disposed adjacent to, and at least partly overlying, the groove 98 at a plurality of locations. These fingers 106 are resilient, and as such, they are configured to flex outward when the antenna is pressed into the groove 98, thus allowing the antenna to enter the groove. Once then antenna passes into the groove 98, the fingers 108 return to their original unflexed position so that they overlie a portion of the groove and the antenna, thus locking the antenna within the groove.

In one embodiment, the resilient finger portions have a first position that overlies the groove. The resilient finger portions are displaceable to a second position that does not overly the groove. As the antenna is inserted into the groove the resilient finger portions are displaceable from the first position to the second position, and when the antenna is received within the groove the resilient finger portions are returnable to the first position to lock the antenna in the groove

Once the antenna is locked in the groove 98, the antenna cover 88 may be attached to the first portion 44 to enclose the antenna 98 in the aforementioned manner. A decorative cover plate 109 may be installed over the antenna cover to provide a finished appearance. Thus arranged, the antenna 60 is embedded within the non-metallic layers of the receptacle so that no portion of the antenna is exposed to the outside environment. This is advantageous because it eliminates the possibility of electric discharge/shock. In addition, the antenna 60 is routed beneath the antenna cover 88 and thus it's performance will not be substantially affected if the user installs a decorative metal faceplate around the perimeter of the antenna cover.

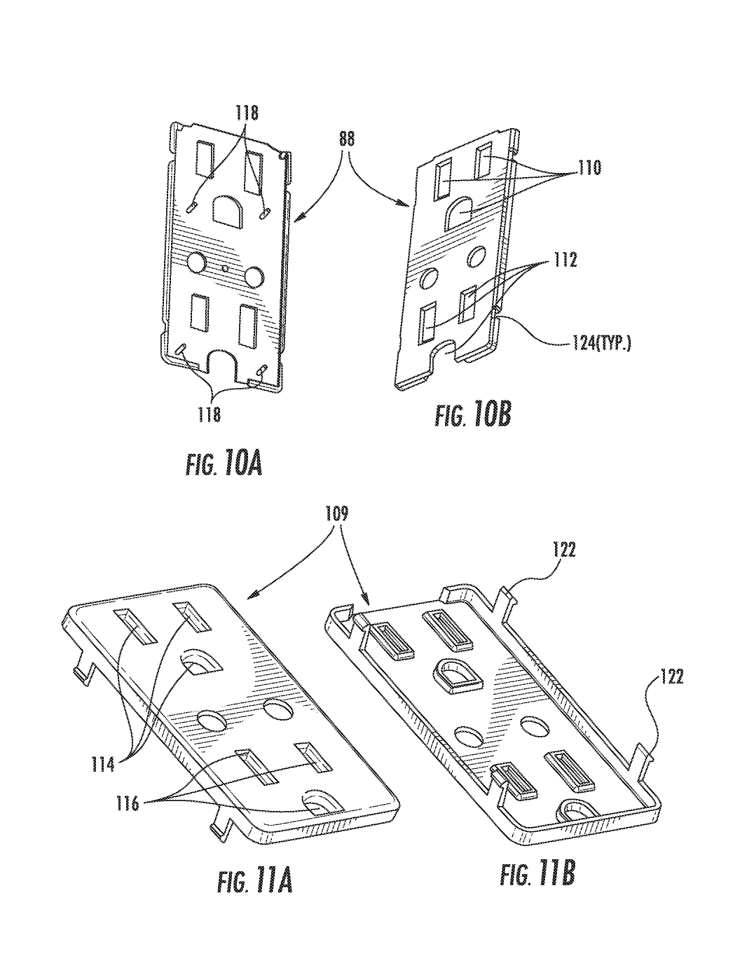

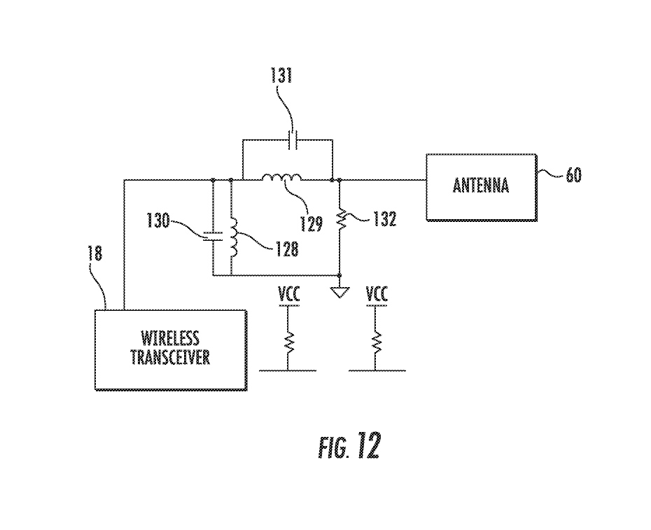

As shown in FIGS. 10A-11B, the antenna cover 88 and cover plate 109 include entry ports 110, 112, 114, 116 that correspond to the respective entry ports 84, 86 of the first portion 44 so the prongs of a plug can be inserted into either the first or second socket 38, 40. The antenna cover 88 and cover plate 109 also include features that enable the cover and cover plate to align with, and lock to, the first portion 44 of the housing. Thus, the antenna cover 88 may include projections 118 configured to align with, and be received within, recesses 120, 125 in the first portion 44 (FIGS. 9A, 9B). The projections 118 may be heat staked to the first portion 44 after the antenna 60 is inserted in the groove 98. Likewise, the cover plate 109 may include a plurality of resilient barbed latches 122 configured to align with openings 124 in the antenna cover 88 and to be removably engageable within recesses 125 of the first portion 44 of the housing (FIGS. 9A, 9B).

As previously noted, the antenna 60 may be coupled to the wireless transceiver 18 (FIG. 3) and may be configured to receive radio frequency (RF) signals for controlling (e.g., powering on/off, etc.) the first and second electrical sockets 38, 40. The antenna 60 is advantageously routed around the sockets 38, 40 and away from other internal metal components of the receptacle 6 in order to reduce the likelihood that the antenna 60 will be susceptible to interference and/or become detuned during use.

As noted, a distal end 104 (see FIG. 8) of the antenna 60 is configured to be coupled (e.g., soldered, etc.) to a circuit on first printed circuit board 52 while a forward facing portion 94 of the antenna is configured to remain free (albeit constrained by groove 98 in the first portion 44 of the housing 42. In the illustrated embodiment, the forward facing portion 94 of the antenna is U-shaped, and has first, second and third legs 94a-c. According to an exemplary embodiment, antenna 60 is designed for the reception and transmission of radio frequency (RF) control signals at a frequency of about 315 MHz. It will be appreciated, however, that the antenna 60 may be designed for the reception and transmission of RF control signals at any of variety of frequencies, including frequencies greater than and less than the 315 MHz frequency, and thus, the antenna may be designed to work at any suitable frequency. This may include, but is not limited to, frequencies in the radio spectrum including, but not limited to the range of 315 Hz to 950 MHz. In embodiments employing IEEE 802.11, the frequency may be up to about 2.4 GHz. In one non-limiting exemplary embodiment, the antenna 60 may be a bare copper wire (20 AWG) or insulated copper wire (24AWB) with a total length of about 6-inches for operation at 315 MHz. It will be appreciated, however, that as operational frequency of the antenna increases, antenna length will decrease. It will be appreciated that these dimensions are provided for exemplary purposes only, and in various alternative embodiments, antenna 60 may be designed to be any of a number of sizes, including sizes greater than and less than those identified above.

The groove 98 in the first portion 44 of the housing thus defines a routing passage for antenna 60 within the first portion 44 of the receptacle 6. Such a routing may advantageously allow the overall length of antenna 60 to be extended (e.g., for tuning the antenna for different applications, etc.) while still allowing the antenna 60 to be positioned behind the antenna cover 88, and away from any metal portions of the receptacle 6.

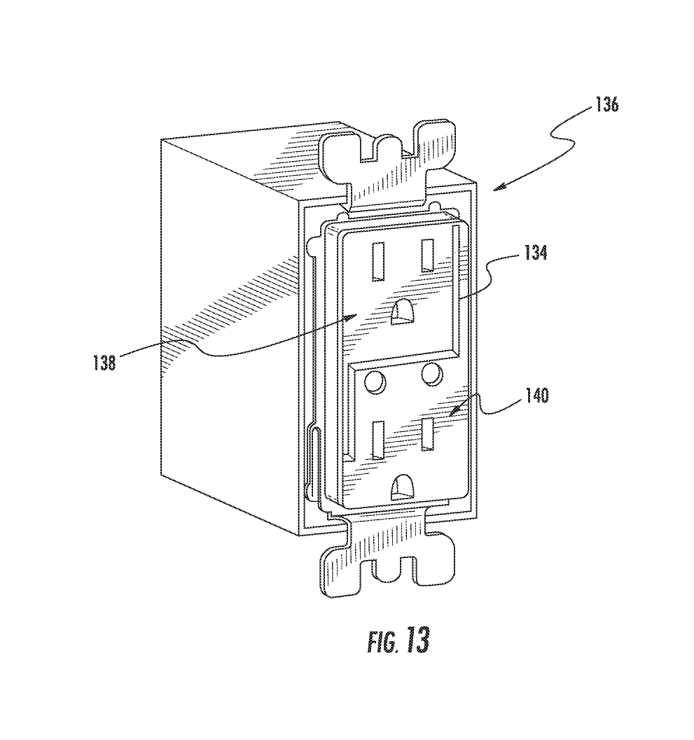

As previously noted, the antenna 60 may be provided with an appropriate impedance matching circuit 126, a non-limiting example of which is illustrated in FIG. 12. The matching circuit 126 may be part of the circuitry disposed on the first printed circuit board 52, or it may be included as part of the wireless transceiver 18.

The matching circuit 126 may couple the antenna 60 to an input/output of the wireless transceiver 18. The matching circuit 126 may include components useful for matching an impedance of the wireless transceiver 18 to an impedance of the antenna 60 over a wide frequency range. In the illustrated embodiment, the matching circuit 126 may include first and second inductors 128, 129, first and second capacitors 130, 131 and a resistor 132. In the illustrated embodiment, the antenna 60 may be coupled in series with the second inductor 129 and the second capacitor 131 (which themselves are coupled in parallel), and may also be coupled in parallel with the first capacitor 130, first inductor 128 and the resistor 132. In one non-limiting exemplary embodiment, the first and second inductors 128, 129 may have inductances of about 18 nanoHenrys (nH) and 22 nH, respectively, while the second capacitor 131 may have a capacitance of about 3.6 pico-Farads (pF). (In this example, the first capacitor 130 and the resistor 132 are unstuffed.) In another non-limiting exemplary embodiment, the first inductor 128 may have an inductance of about 22 nH and the second inductor 129 may have an inductance of about 18 nH. (In this example, the first and second capacitors 130, 131 and the resistor 132 are unstuffed.) It will be appreciated that these are merely exemplary implementations of a matching circuit 126 for the antenna 60, and that others may also be used. In addition, the impedance matching functionality may alternatively be included in the wireless transceiver 18 and need not be provided on the first circuit board 52.

FIG. 13 illustrates an alternative embodiment of the disclosed arrangement in which antenna 134 is routed in a Z-shaped manner rather than the U-shaped routing of the antenna 60 of FIG. 8. The receptacle 136 of this embodiment may have some or all of the physical and operational characteristics of the receptacle 6 of FIGS. 4-11B with the exception of the antenna routing plan and the impedance matching circuit. As can be seen, antenna 134 is routed so as to avoid the sockets 138, 140 in order to minimize interference from one or more metal plugs inserted into the sockets. Although not shown, antenna 134 has a rearward extending portion that passes through an opening in the first portion 44 of the housing and engages the first printed circuit board 52.

The receptacle 6 (or 136) may optionally include additional features such as a visual indicator feature and a user interface feature 28. As shown in FIGS. 4 and 6, the visual indicator feature may comprise a light pipe 150 and the user interface feature 28 may comprise a push button 152. Light pipe 150 may permit an internal LED or other light source to be visible to a user. Light pipe 150 may be configured to function as a status indicator such as to indicate to a user when the controlled electrical receptacle 6 is in its on position or off position. For example, when light pipe 150 is on and showing GREEN, the controlled receptacle (e.g., first or second socket 38, 40) will be OFF, and when light pipe 150 is off, the controlled receptacle (i.e., first or second socket 38, 40) will be ON. Alternatively, when light pipe 150 is on and showing GREEN, the controlled receptacle (e.g., first or second socket 38, 40) may be ON so the user can affirmatively see that the outlet is engaged with power (in this embodiment, when the light pipe is off, the receptacle will be OFF). Light pipe 150 may also be configured to illuminate an area around electrical receptacle 6 to provide guidance to a user. Light pipe 150 may also be configured to provide a visual display for a user attempting to program electrical receptacle 6. According to the various alternative embodiments, the light pipe and/or the LED may optionally be omitted. In FIG. 6 the light pipe 150 is shown as being a one-piece unitary body that is formed of a substantially transparent material. Light pipe 150 may have a first end supported adjacent to a light source (e.g., disposed on the first printed circuit board 52) and a second end supported near the outer front surface of electrical receptacle 6.

The user interface 28 (FIG. 3) is illustrated as being a push button 152 configured to be manually actuated by a user to control a function of electrical receptacle 6. In one embodiment, push button 152 provides a user with a manual interface for controlling the controlled electrical sockets 38, 40. For example, a user may press push button 152 inward to turn the first and/or second electrical socket 38, 40 on or off. One or more user interfaces may also be provided to control a circuit interrupter (e.g., GFCI, AFCI, etc.) device if one is provided. For example, the user interface may control the “reset” and/or “test” function of such a GFCI device. Push button 140 is configured for axial movement when pressed by a user. It will be appreciated that in some embodiments the user interface and/or push button may be omitted. Referring to FIG. 9A, 9B, light pipe 150 and push button 152 are shown as being received in apertures 154, 156 in the first portion 44 of the housing 50. The light pipe 150 and push button 152 also pass through similar apertures in the cover plate 109, antenna cover 88, and middle portion 50 so that these components are accessible to a user and can also reach first circuit board 52.

As will be appreciated, the disclosed receptacle 6 can function as a receptacle or outlet providing a way to provide 120V 60 Hz AC power to devices much like a regular receptacle but with the added feature of being controlled via wireless 315 MHz (or other) signal. Various wireless devices, such as, but not limited to, occupancy sensors, photocells, switches, and door/window sensors can be tied to the receptacle to provide control over the current outlet.

The disclosed receptacle 6 may be used as a replacement receptacle for controlling lighting, computers, or other accessories plugged into a standard wall socket. The receptacle 6 may fit into a standard wallbox and may replace a regular receptacle to provide local and remote ON/OFF switching of connected lighting or accessories. The receptacle can respond to commands sent from a wireless-enabled device such as rocker switch, keycard, door/window sensor, toggle switch, or occupancy sensor. In addition, the receptacle can be programmed via a learn-programming button (e.g., user interface 28) or via wirelessly-controlled remote learning. The receptacle can be configured to handle loads up to 15 Amps.

In one embodiment, the disclosed receptacle may find application in hospitality (i.e., hotel) applications. For example, energy savings may be achieved when the receptacle turns off any plugged-in accessory when there is no occupant in the associated hotel room. The occupancy of the room can be determined via keycard switch, door/window sensor, occupancy sensor, wall switch, or the like.

Further, the receptacle may include a current sensing feature that would sense the current flowing through the individual sockets 38, 40 to the load(s) and to allow for shut down (i.e., trip) of the receptacle 6 if overloaded. The purpose of the current sensing circuit is twofold: (1) monitor the load to know how much power a load is using, and (2) know that a load on the controlled outlet exists. Thus, the current sensing application can be used for metering, reporting status, as well as safety. The current sensing feature could be implemented as one or more Hall effect sensors, or one or more small current transformers.

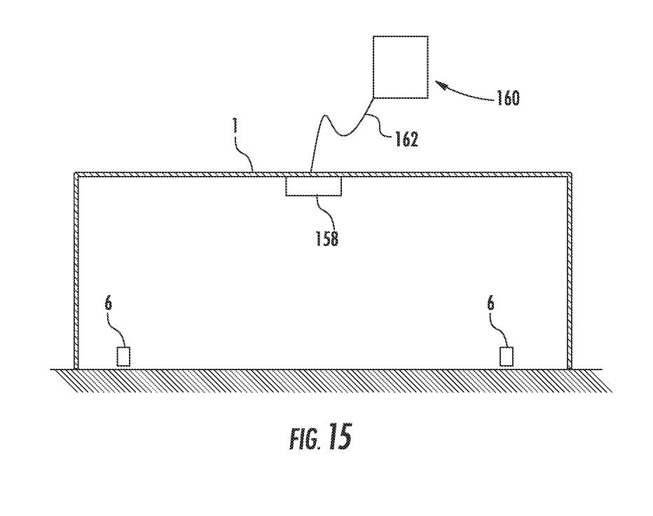

Moreover, providing a receptacle 6 having current sensing functionality in the front of a daisy chained array of additional “slave” receptacles can provide protection for the receptacle 6 as well as the slave outlets. For example, a first receptacle could be the controllable receptacle 6. This receptacle 6 may have an additional set of HOT and NEUTRAL wire connections to allow for cascading of additional outlets behind. Thus, power to the controllable receptacle 6 and all outlets following the controllable receptacle will flow through the relay within the controllable receptacle. This means all of the outlets following the controllable receptacle 6 will also be controllable. Such an arrangement is shown in FIG. 14, in which a controllable receptacle 6 is wired in serial fashion to a pair of additional slave receptacles 164. In the illustrated arrangement, the controllable receptacle 6 can receive wireless signals 8 from an occupancy sensor 2 mounted in the room 1, and can, in turn, control power to its own sockets 38, 40 as well as to one or both of the sockets of the slave receptacles 164. As such, the slave receptacles 164, which can be conventional receptacles, can be controlled via the controllable receptacle 6 so that they are turned off or on depending upon the occupancy status of the room 1. As with previous embodiments, occupancy status can be determined via keycard switch, door/window sensor, occupancy sensor, wall switch, or the like.

As will be appreciated, this arrangement has the advantage that only a single “intelligent” controllable receptacle 6 can be provided in a particular room, and can be used to provide control of a larger number of conventional (i.e., less expensive) receptacles dispersed throughout the room. It will be appreciated that although only a pair of additional slave receptacles 164 are shown, that fewer or greater numbers of conventional slave receptacles 164 as desired. In addition, although not shown, it will be appreciated that one or more power strips, surge protectors, or extension cords may be plugged into one or both sockets 38, 40 of the controllable receptacle 6 to add additional plugs for controlling additional connected devices. For example, a computer may be plugged into a non-controlled outlet to maintain a constant ON state, while “accessory devices” such as a printer, desk light, stereo, and the like would all be plugged into a power strip which in turn is plugged into a controlled socket 38, 40 of the controllable receptacle 6. This arrangement allows a remote switch and/or occupancy sensor to control the accessory devices.

The disclosed arrangement allows for the use of a single “intelligent” controllable receptacle 6, followed by several conventional receptacles, to facilitate a fully controlled room. It will be appreciated that where all of the outlets are tied together serially, the first outlet in the chain (i.e., the controllable receptacle 6) will be required to handle all of the current going back to the main breaker.

As previously noted, the receptacle 6 may include a current sensing feature that can be used to implement a load metering function. In the embodiment shown in FIG. 15, the current sensing circuit may be used to measure the load and the total amount of time the load is powered “on.” This information may be reported back wirelessly (via wireless transceiver 18 (FIG. 3) to a transceiver 158 located near the receptacle 6. The transceiver 158 may transmit the information to a central controller 160 through a wired or wireless communications link 162. The controller 160 may be configured to track energy usage in the building in which the controllable receptacle 6 is installed (FIG. 14). To optimize energy efficiency, a query can be made to the receptacle 6, and details may be reported on load usage. The current sensing functionality may be used to determine if a load is on and how much load/power is being utilized. The central controller 160 may determine that the receptacle 6 and its loaded devices should be shut off if total measured power exceeds a certain usage. Shut off may be accomplished by sending a wireless signal from transceiver 158 to transceiver 18 of the receptacle 6. Further, if load ever exceeds the receptacle rating the current sensing feature can operate to turn off power to the receptacle 6. A visual indicator (i.e., a blinking warning light) may also provide local indication of an overload.

It is important to note that the terms used herein are intended to be broad terms and not terms of limitation. For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. Such joining may relate to a mechanical and/or electrical relationship between the two components.

It is also important to note that the construction and arrangement of the elements of the electrical receptacle as shown in the exemplary embodiments are illustrative only. Although only a few embodiments of the present invention have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the claims. Accordingly, all such modifications are intended to be included within the scope of the appended claims.

Some embodiments of the disclosed device may be implemented, for example, using a storage medium, a computer-readable medium or an article of manufacture which may store an instruction or a set of instructions that, if executed by a machine (i.e., processor or microcontroller), may cause the machine to perform a method and/or operations in accordance with embodiments of the disclosure. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory (including, but not limited to, non-transitory memory), removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision additional modifications, features, and advantages within the scope and spirit of the claims appended hereto.

What is claimed is:

1. A controllable electrical receptacle, comprising:
a housing comprising a first housing portion having openings comprising at least one electrical socket;
an antenna at least partially disposed within a groove in a front face of said first housing portion, wherein the groove is routed around said at least one electrical socket, the antenna comprising a wire element having a rearward extending portion and a forward facing portion, wherein the rearward extending portion is coupled to a circuit, and wherein the forward facing portion is positioned within said groove; and
a wireless transceiver coupled to said circuit, the wireless transceiver configured to receive wireless signals and to control power to said at least one socket in response to said wireless signals.

2. The controllable electrical receptacle of claim 1, further comprising an antenna cover portion positioned over said first housing portion and said forward facing portion of said antenna.

3. The controllable electrical receptacle of claim 1, wherein the at least one socket comprises first and second sockets, and the wireless transceiver is configured to selectively independently control power to said first and second sockets in response to said wireless signals.

4. The controllable electrical receptacle of claim 1, wherein said first housing portion comprises a resilient finger portion at least partially overlying said groove, the resilient finger portion configured to lock the wire element in the groove.

5. The controllable electrical receptacle of claim 4, the resilient finger portion having a first position that overlies said groove, the resilient finger portion being displaceable to a second position that does not overly said groove, wherein as the wire member is inserted into the groove the resilient finger portion is displaceable from said first position to said second position, and wherein when the wire member is received within the groove the resilient finger portion is returnable to the first position to lock the wire element in the groove.

6. The controllable electrical receptacle of claim 1, further comprising a user interface for adjusting operational parameters of the receptacle.

7. The controllable electrical receptacle of claim 1, further comprising a current sensor for sensing current supplied to a connected load and a total time said current is supplied to said connected load.

8. The controllable receptacle of claim 7, wherein the receptacle is configured to monitor load usage information and report said load usage information to a central controller configured to track energy usage in an associated space.

9. An electrical receptacle, comprising:
a housing comprising a first housing portion, the first housing portion comprising an electrical socket;
an antenna having a rearward extending portion and a forward facing portion, the rearward extending portion coupled to a circuit, the forward facing portion positioned within a groove in said first housing portion, the groove routed around said electrical socket; and
a wireless transceiver coupled to said circuit, the wireless transceiver configured to receive wireless signals and to control power applied to said socket in response to said wireless signals.

10. The electrical receptacle of claim 9, wherein the housing comprises first and second electrical sockets, and the wireless transceiver is configured to receive said wireless signals and to control power applied to the first and second electrical sockets in response to said wireless signals.

11. The electrical receptacle of claim 10, wherein the wireless transceiver is configured to selectively independently control power to said first and second sockets in response to said wireless signals.

12. The electrical receptacle of claim 9, wherein the groove is disposed in a forward facing surface of said first housing portion, the electrical receptacle further comprising an antenna cover portion disposed over said first housing portion and said forward facing portion of said antenna to sandwich the antenna between the first housing portion and the antenna cover portion.

13. The electrical receptacle of claim 9, wherein said first housing portion comprises a resilient finger portion at least partially overlying said groove, the resilient finger portion configured to lock the antenna in the groove.

14. The electrical receptacle of claim 13, the resilient finger portion being resiliently movable between first and second positions, wherein in the first position the resilient finger portion at least partially overlies said groove, and wherein in the second position the resilient finger portion does not overlie said groove.

15. The electrical receptacle of claim 14, wherein as the wire member is inserted into the groove the resilient finger portion is displaceable from said first position to said second position, and wherein when the wire member is received within the groove the resilient finger portion is returnable to the first position to lock the wire element in the groove.

16. The electrical receptacle of claim 9, further comprising a user interface for adjusting operational parameters of the receptacle.

17. The electrical receptacle of claim 9, further comprising a current sensor for sensing current supplied to a connected load and a total time said current is supplied to said connected load.

18. The electrical receptacle of claim 17, wherein the receptacle is configured to report a total amount of supplied power to a central controller configured to track energy usage in an associated space.

19. A controllable electrical receptacle system, comprising:
a controllable electrical receptacle comprising:
a first housing portion having openings comprising at least one electrical socket;
an antenna received within a groove in a front face of said first housing portion, wherein the groove is routed around said at least one electrical socket, the antenna comprising a wire element having a rearward extending portion and a forward facing portion, the rearward extending portion coupled to a circuit, the forward facing portion disposed within said groove; and
a wireless transceiver coupled to said circuit, the wireless transceiver configured to receive wireless signals and to control power to said at least one socket in response thereto; and
a wireless device configured to transmit said wireless signals in response to a sensed occupancy condition in a monitored space.

20. The controllable electrical receptacle system of claim 19, further comprising an antenna cover portion positioned over said first housing portion and said forward facing portion of said antenna.

21. The controllable electrical receptacle system of claim 19, wherein said first housing portion comprises a resilient finger portion at least partially overlying said groove, the resilient finger portion configured to selectively lock the wire element in the groove.

22. The controllable electrical receptacle system of claim 19, further comprising a current sensor for sensing current supplied to a connected load and a total time said current is supplied to said connected load.

23. The controllable electrical receptacle system of claim 22, wherein the receptacle is configured to monitor load usage information and report said load usage information to a central controller configured to track energy usage in an associated space.

24. The controllable electrical receptacle system of claim 19, further comprising a second receptacle electrically coupled to the controllable electrical receptacle, the second receptacle having a first electrical socket, wherein power to the first electrical socket of the second receptacle is controllable via the controllable electrical receptacle.

25. The controllable electrical receptacle system of claim 24, the second receptacle comprising a second electrical socket, wherein power to the second electrical socket of the second receptacle is not controllable by the controllable electrical receptacle.

26. The controllable electrical receptacle system of claim 19, further comprising second and third electrical receptacles serially connected to the controllable electrical receptacle, wherein power to the second and third electrical receptacles is controllable via said controllable electrical receptacle in response to said received wireless signals.

27. The controllable electrical receptacle system of claim 19, further comprising a daisy chained array of slave receptacles connected to the controllable electrical receptacle, the controllable electrical receptacle having a current sensor for sensing current flowing through the at least one electrical socket to allow for shut down of the controllable electrical receptacle and the slave receptacles if the controllable electrical receptacle is overloaded.

28. The controllable electrical receptacle system of claim 19, wherein the second and third receptacles are conventional electrical receptacles.

29. The controllable electrical receptacle system of claim 19, wherein the wireless device is selected from the list consisting of an occupancy sensor, a keycard switch, and door sensor, a window sensor and a wall switch.
